(19) United States
(12) Patent Application Publication
(10) Pub. No.: US 2011/0222088 A1
(43) Pub. Date: Sep. 15, 2011

(54) IMAGE FORMING APPARATUS

(76) Inventor: Yoshio FUKUDA, Osaka-shi (JP)

(21) Appl. No.: 13/043,939

(22) Filed: Mar. 9, 2011

(30) Foreign Application Priority Data
Mar. 15, 2010 (JP) 2010-057429

(51) Int. Cl. G06K 15/16; G06K 15/02

(52) U.S. Cl. 358/1.12; 358/1.14

(57) ABSTRACT

A control portion includes a CPU and a ROM. The ROM includes a first memory area, a second memory area, and a third memory area. The first memory area stores the correspondence of a user's input operation at a touch panel to a first type of information on image forming processing. The second memory area stores the correspondence of a detection result output from a sensor to the first type of information. The third memory area stores the correspondence of a detection result output from the sensor to a second type of information on the image forming processing. If the touch panel is not faulty, the CPU performs the image forming processing based on the contents of the first and third memory areas. If the touch panel is faulty, the CPU performs the image forming processing based on the contents of the second and third memory areas.

### CROSS REFERENCE

This Nonprovisional application claims priority under 35 U.S.C. §119(a) on Patent Application No. 2010-057429 filed in Japan on Mar. 15, 2010, the entire contents of which are hereby incorporated by reference.

### BACKGROUND OF THE INVENTION

The present invention relates to an image forming apparatus fitted with an input operation portion for receiving an input operation of information on image forming processing, the apparatus receiving an input operation of information on the image forming processing, if the input operation portion is faulty, by using a sensor fitted to the apparatus for another purpose.

When an image forming apparatus is instructed to start image forming processing, the apparatus performs the image forming processing based on a selected mode and set conditions of image formation. The mode may be either a color image forming mode for full color image forming processing or a monochromatic image forming mode for monochromatic image forming processing. The conditions may be document size, paper size, image density, image forming ratio, and number of copies.

An image forming apparatus is fitted with an input operation portion for receiving input operation of information on image forming processing. The information includes an instruction to start the image forming processing, a selected mode, and changed conditions of image formation. On the input operation portion, a print key (start button), a mode selection button, a numerical keypad, etc. are arranged. The user enters with the print key an instruction to start the image forming processing. The user sets numeric information on conditions of image formation with the numerical keypad.

In recent years, image forming apparatus have been requested to be multifunctional. Accordingly, a user needs to enter a wide range of information on image forming processing into an image forming apparatus before the apparatus starts the processing. The input operation portion of the apparatus includes an operating panel consisting of a display, which may be an LCD, and a touch panel. The display displays icons of operating keys. The touch panel detects the position pressed by the user on the top of the display. By switching the displayed icons, it is possible to receive input operations from a number of operating keys on the single operating panel.

If the input operation portion is faulty, the user cannot perform input operation of information on the image forming processing, so that the image forming apparatus cannot be operated even if the image forming portion of the apparatus is not faulty.

In particular, the operating panels of image forming apparatus are becoming larger in size, and image forming apparatuses are proposed on the display on which all keys including a numeric keypad and a print key are displayed. If the touch panel of the operating panel of such an image forming apparatus is faulty, even an instruction operation to start image forming processing cannot be received into the apparatus.

As disclosed by JP2009-073045A, a conventional system is proposed that includes a plurality of image forming apparatuses connected through a network. If the input operation portion of any of the apparatuses is faulty, the input operation portion of another operates for that portion.

The conventional system makes it possible to receive input operation of information on image forming processing into a faulty image forming apparatus through another image forming apparatus. This system cannot be applied to a singly installed image forming apparatus.

It is the object of the present invention to provide an image forming apparatus for receiving input operation of information on image forming processing if the input operation portion of the apparatus is faulty even when the apparatus is singly installed.

### SUMMARY OF THE INVENTION

An image forming apparatus according to the present invention includes an input operation portion, an image forming portion, a fault detector, a sensor, a first memory portion, a second memory portion, a third memory portion, and a control portion. The input operation portion receives input operation of information on image forming processing in the image forming apparatus. The image forming portion performs the image forming processing on a sheet of paper. The fault detector detects a fault in the input operation portion. The sensor detects the user's action for the image forming processing. The first memory portion stores the correspondence of the user's input operation at the input operation portion to a first type of information on the image forming processing. The second memory portion stores the correspondence of a detection result output from the sensor to the first type of information. The third memory portion stores the correspondence of a detection result output from the sensor to a second type of information on the image forming processing. If the fault detector has detected no fault in the input operation portion, the control portion controls the operation of the image forming portion based on the contents of the first and third memory portions. If the fault detector has detected a fault in the input operation portion, the control portion controls the operation of the image forming portion based on the contents of the second and third memory portions.

### BRIEF DESCRIPTION OF THE DRAWINGS

FIG. 1 is a schematic sectional front view of an image forming apparatus according to a first embodiment and a second embodiment of the present invention.

FIG. 2 is a block diagram of the control portion of the image forming apparatus.

FIG. 3 is an outline drawing showing the arrangement of document size sensors in the image forming apparatus.

FIG. 4 is a top plan of the input operation portion of the image forming apparatus.

FIGS. 5A-5C are tables of the contents stored in the control portion in the first embodiment.

FIG. 6 is a flowchart of the procedure performed by the control portion.

FIG. 7 shows the operation change screen displayed on the input operation portion in the first embodiment.

FIGS. 8A-8C show the operation change screens displayed on the input operation portion in the second embodiment.

### DETAILED DESCRIPTION OF THE INVENTION

With reference to the accompanying drawings, an image forming apparatus 1 embodying the present invention will be described below.

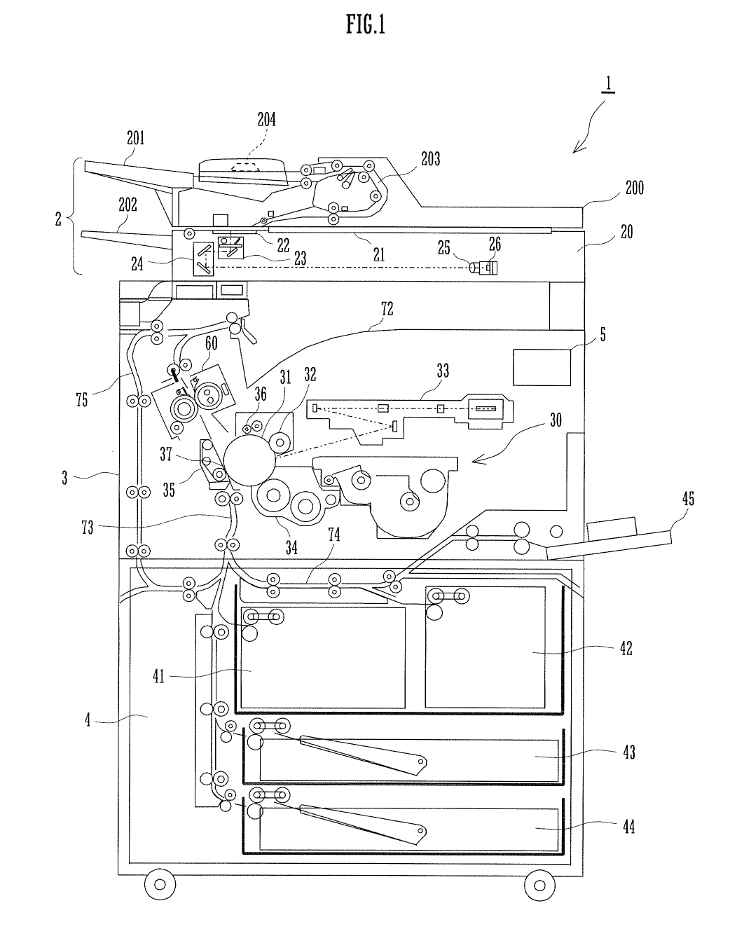

As shown in FIG. 1, the image forming apparatus 1 includes an image reading portion 2, an image forming portion 3, a paper feed portion 4, and a control portion 5, which controls the whole apparatus. The apparatus 1 is fitted with an input operation portion 6 on its front side. The input operation portion 6 will be described later on.

The image forming apparatus 1 electrophotographically forms a color image or a monochromatic image on a sheet of paper in one of three operation modes, which are a copier mode, a printer mode, and a fax mode. The sheet may be a sheet of ordinary paper, a sheet of photographic paper, or an OHP film.

The image reading portion 2 includes a scanner portion 20 and an automatic document feeder 200.

The scanner portion 20 includes a first document platform 21, a second document platform 22, a light source portion 23, a mirror portion 24, a lens 25, and a CCD (charge coupled device) 26. The scanner portion 20 reads the image on a document and generates image data.

The automatic document feeder 200 has a document path 203 leading from a document feed tray 201 through the upper side of the second document platform 22 to a document delivery tray 202. The feeder 200 feeds the documents on the feed tray 201 one after another along the path 203 to the upper side of the second document platform 22. The feeder 200 is so supported pivotably at its rear edge as to open and close the upper side of the first document platform 21. By raising the front edge of the feeder 200 so as to expose the upper side of the first document platform 21, it is possible to set a document on this platform manually without using the feeder 200. The platforms 21 and 22 are hard glass plates.

The light source portion 23 and mirror portion 24 move in the secondary scanning directions under and along the document platforms 21 and 22. The speed at which the mirror portion 24 moves is half (½) of the speed at which the light source portion 23 moves. The light source portion 23 carries a light source and a first mirror. The mirror portion 24 carries a second mirror and a third mirror.

In a passing document reading mode, the image reading portion 2 reads the image on the document being fed by the automatic document feeder 200. In this mode, the light source portion 23 stops under the second document platform 22. The light source on the portion 23 irradiates with light the under side of the document passing over the platform 22. The first mirror on the light source portion 23 directs at the mirror portion 24 the light reflected by the under side of the document.

In a resting document reading mode, the image reading portion 2 reads the image on the document set on the first document platform 21. In this mode, the light source portion 23 and mirror portion 24 move in the secondary scanning directions under the platform 21. The light source on the portion 23 irradiates with light the under side of the document on the platform 21. The first mirror on the light source portion 23 directs at the mirror portion 24 the light reflected by the under side of the document.

Whether the automatic document feeder 200 is used or not, the light reflected by the under side of the document is led to the second and third mirrors on the mirror portion 24, with the optical path length constant, and is then incident on the CCD 26 via the lens 25.

The CCD 26 outputs an electric signal in accordance with the quantity of light reflected by the under side of the document. The electric signal is then input as image data to the control portion 5. Thus, the image reading portion 2 reads an image on a document and generates image data. When necessary, the control portion 5 outputs the image data to the image forming portion 3.

The image forming portion 3 is positioned under the image reading portion 2 and includes an electrophotographic processing portion 30 and a fixing portion 60. The processing portion 30 includes a photoreceptor drum 31, a charger 32, an exposure portion 33, a developing portion 34, a transfer portion 35, and a cleaning portion 36.

The charger 32 charges the cylindrical surface of the photoreceptor drum 31 uniformly to a specified electric potential.

The exposure portion 33 exposes the charged surface of the photoreceptor drum 31 to light according to image data. The exposure forms on the drum surface an electrostatic latent image according to the image data.

The developing portion 34 develops the electrostatic latent image on the cylindrical surface of the photoreceptor drum 31 with developer so as to form a developer image there.

The transfer portion 35 transfers the developer image on the cylindrical surface of the photoreceptor drum 31 to a sheet of paper passing through the transfer position 37 between this portion and the drum surface.

The cleaning portion 36 removes and recovers the developer remaining on the cylindrical surface of the photoreceptor drum 31 after the developer image is transferred to the sheet.

The fixing portion 60 includes a heating roller and a pressing roller. While the sheet bearing the developer image is passing through the nip between the heating and pressing rollers, the fixing portion 60 heats and presses the sheet so as to fix the image to it.

A paper delivery tray 72, which is a paper delivery portion, is formed in an upper portion of the image forming portion 3 and holds the printed sheet to which the developer image is fixed.

The paper feed portion 4 is positioned under the image forming portion 3 and includes paper cassettes 41-44, which are paper holding portions for holding unprinted sheets of paper, and a hand-feed tray 45.

A first paper path 73, a second paper path 74, and a third paper path 75 are formed in the paper feed portion 4 and image forming portion 3.

The first paper path 73 leads substantially vertically from the paper feed portion 4 through the electrophotographic processing portion 30 and the fixing portion 60. The path 73 so curves substantially horizontally over the fixing portion 60 as to deliver a sheet of paper to the paper delivery tray 72.

The second paper path 74 leads substantially horizontally in the paper feed portion 4 from the hand-feed tray 45 and joins the first paper path 73 at a point upstream from the transfer position 37 between the photoreceptor drum 31 and the transfer portion 35.

The third paper path 75, which is a paper path for double-side printing, branches off from the first paper path 73 at a point downstream from the fixing portion 60 and joins the path 73 at a point upstream from the transfer position 37.

A sheet of paper can be fed from one of the paper cassettes 41, 43 and 44 along the first paper path 73 to the transfer position 37 in the electrophotographic processing portion 30. A sheet of paper can be fed from the paper cassette 42 or the hand-feed tray 45 along the second paper path 74 and first paper path 73 in that order to the transfer position 37.

After a sheet of paper passes through the fixing portion 60, the sheet is fed upward along the first paper path 73. The sheet is then delivered to the paper delivery tray 72 or switched back and fed to a post-treatment device (not shown) or the third paper path 75.

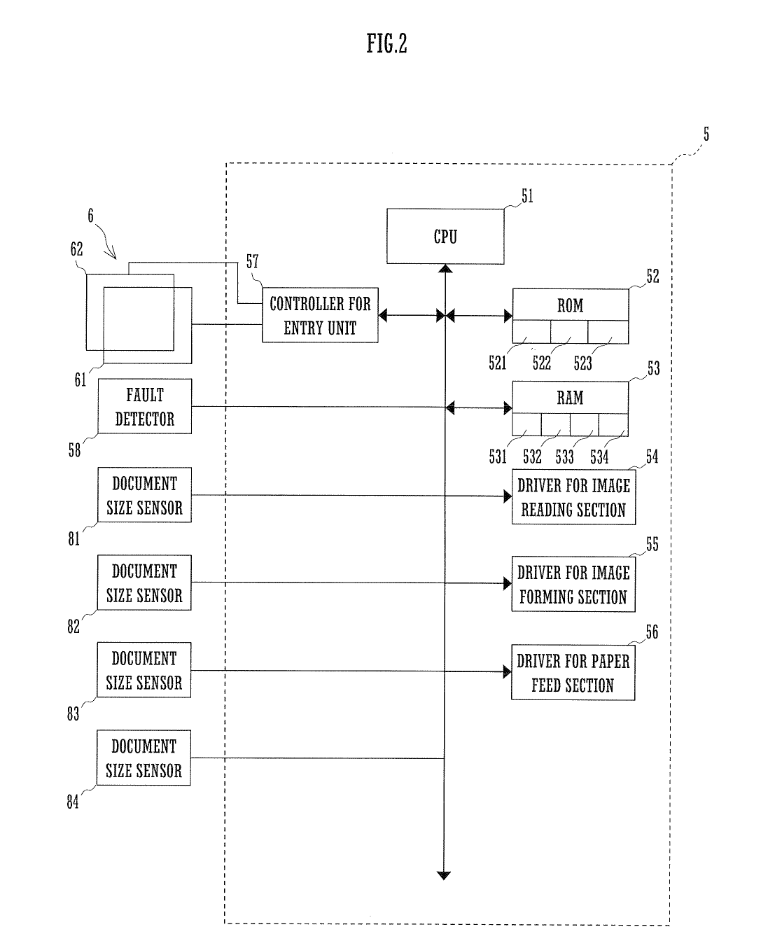

As shown in FIG. 2, the control portion 5 includes a CPU 51, a ROM 52, a RAM 53, a driver 54 for the image reading portion, a driver 55 for the image forming portion, a driver 56 for the paper feed portion, and a controller 57 for the input operation portion.

The CPU 51 is connected to the ROM 52, the RAM 53, the drivers 54-56, the controller 57, a fault detector 58, document size sensors 81-84, etc.

The ROM 52 stores the program that controls the operation of the CPU 51.

The RAM 53 temporarily stores the data input to and output from the CPU 51. The RAM 53 includes memory areas 531-534, which respectively store the image density, paper size, number of copies and document size set by a user.

The driver 54 is connected to the drive mechanism (not shown), which may be a motor, in the image reading portion 2.

The driver 55 is connected to the drive mechanism (not shown), which may be a motor, in the image forming portion 3.

The driver 56 is connected to the drive mechanism (not shown), which may be a motor, in the paper feed portion 4.

The controller 57 is connected to the input operation portion 6.

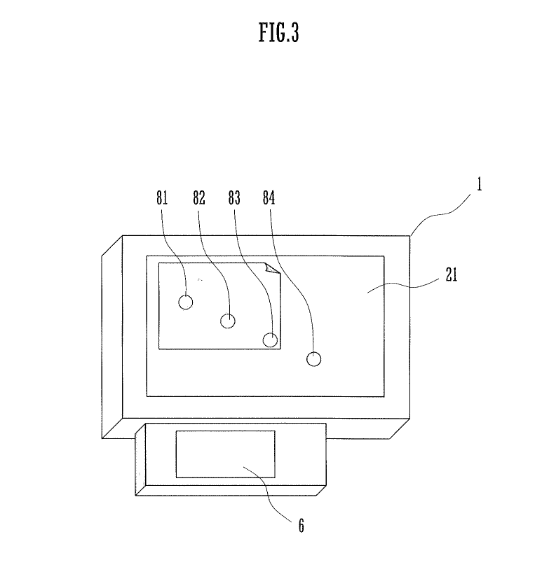

As shown in FIG. 3, the input operation portion 6 is positioned on the front side of the image forming apparatus 1. The input operation portion 6 includes a display 61, which may be an LDC or an EL. The upper side of the display 61 is covered with a touch panel 62. The controller 57 displays an image of a key switch or another operating member on the display 61 based on the display data input from the CPU 51 to the controller.

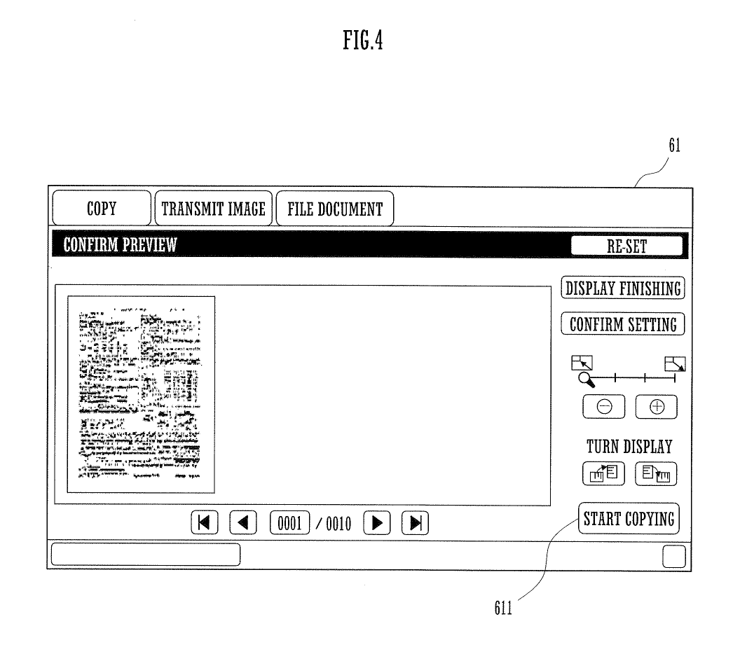

As shown in FIG. 4, the operating member displayed on the display 61 may be a start button 611 for receiving an instruction operation to start image forming processing. The controller 57 outputs to the CPU 51 operation data representing the position touched by the input operation of the user on the touch panel 62.

Alternatively, the ROM 52 might hierarchically store display data representing a plurality of operating members, which could be displayed hierarchically on the display 61.

The fault detector 58 detects whether the touch panel 62 is faulty. Dust on or damage to the panel 62 may keep part or the whole of it turned on. If the panel 62 keeps outputting identical detection signals for a specified time or longer, the detector 58 determines that the panel 62 is faulty. Then, the detector 58 outputs a fault signal to the CPU 51.

With reference to FIG. 3, the document size sensors 81-84 detect the size of the document put manually on the first document platform 21 by the user and output detection data the CPU 51.

The document size sensors 81-84 may be optical sensors fitted under the first document platform 21. The optical sensors receive the extraneous light transmitted through the platform 21 and detect the size of the document on the platform based on how the document cuts off the light.

Alternatively, each of the document size sensors 81-84 may consist of a light emitter and a light receiver that are fitted respectively over and under the first document platform 21.

Based on the operation data input from the controller 57 to the CPU 51 and the display data being output from the CPU to the controller, the CPU 51 identifies the information (for example, image density, paper size, number of copies, etc.) set about the image forming processing by the user. In accordance with the program in the ROM 52, the CPU 51 outputs to the drivers 54-56 drive data according to the identified information and the detection data from the document size sensors 81-84.

Each of the drivers 54-56 drives the associated drive mechanism based on the drive data input from the CPU 51 to the driver.

The ROM 52 includes memory areas 521-523, which correspond to the first, second and third memory portions respectively of the present invention.

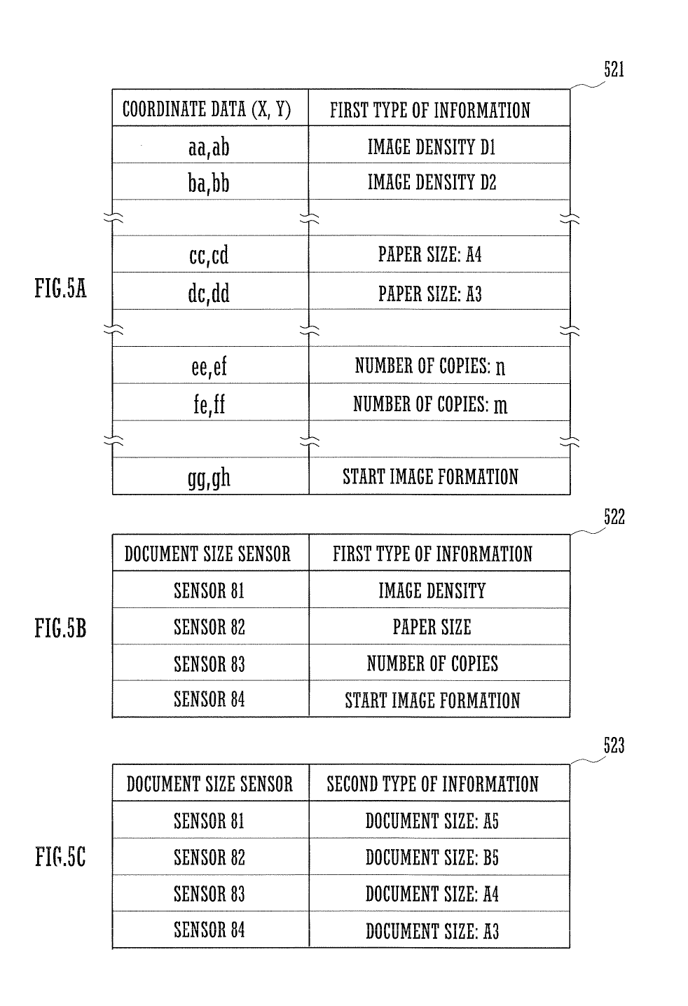

As shown in FIG. 5A, the memory area 521 of the ROM 52 stores the correspondence of a first type of information on the image forming processing to the input operation information of the user in the input operation portion 6. This type of information includes conditions of image formation, which are image density, paper size and number of copies, and an instruction to start the image forming processing.

The controller 57 inputs to the CPU 51 the input operation information as coordinate data on a screen on the display 61.

The CPU 51 reads from the memory area 521 of the ROM 52 the piece of information of the first type that corresponds to the coordinate data input from the controller 57 to the CPU. If the input data represents image density, paper size, or number of copies, the CPU 51 stores the read piece of information in the associated memory area 531, 532 or 533 of the RAM 53. If the input data represents an instruction to start the image forming processing, the CPU 51 starts the image forming processing by activating the drivers 54-56 based on the contents of the memory areas 531-534 of the RAM 53.

When the image forming apparatus 1 is started up, middle-level image density, A4 paper size, one copy, and A4 document size are set as default values in the memory areas 531-534 respectively of the RAM 53.

As shown in FIG. 5B, the memory area 522 of the ROM 52 stores the correspondence of the first type of information to the detection data output from the document size sensors 81-84 in a first embodiment of the present invention.

While the touch panel 62 is faulty, the CPU 51 reads from the memory area 522 of the ROM 52 the piece of information of the first type that is associated with the document size sensor 81, 82 or 83 from which one or more detection signals are input to the CPU. Then, the CPU 51 changes the contents of the associated memory area 531, 532 or 533 of the RAM 53 according to the number of times the detection signal or signals have been input to the CPU.

Every time a detection signal is input from the document size sensor 81 to the CPU 51 while the touch panel 62 is faulty, the CPU increases image density. Every time detection signals are input from the document size sensors 81 and 82 to the CPU 51 while the panel 62 is faulty, the CPU increases paper size. Every time detection signals are input from the document size sensors 81-83 to the CPU 51 while the panel 62 is faulty, the CPU increments the number of copies.

If a detection signal is input from the document size sensor 84 to the CPU 51 while the panel 62 is faulty, the CPU starts the image forming processing by activating the drivers 54-56 based on the contents of the memory areas 531-534 of the RAM 53. In this case, the CPU 51 reads from the memory area 523 of the ROM 52 the document size represented by the detection signal or signals output from one or more of the document size sensors 81-84 just before the CPU starts the image forming processing.

As shown in FIG. 5C, the memory area 523 of the ROM 52 stores the correspondence of a second type of information on the image forming processing to the detection data from the document size sensors 81-84. This type of information is document size.

While the touch panel 62 is not faulty, the CPU 51 reads from the memory area 523 of the ROM 52 the document size represented by the detection signal or signals output from one or more of the document size sensors 81-84 to the CPU. The CPU 51 stores the read document size in the memory area 534 of the RAM 53.

While the touch panel 62 is faulty, the CPU 51 reads from the memory area 523 of the ROM 52 the document size represented by the detection signal or signals output from one or more of the sensors 81-84 to the CPU just before the CPU starts the image forming processing.

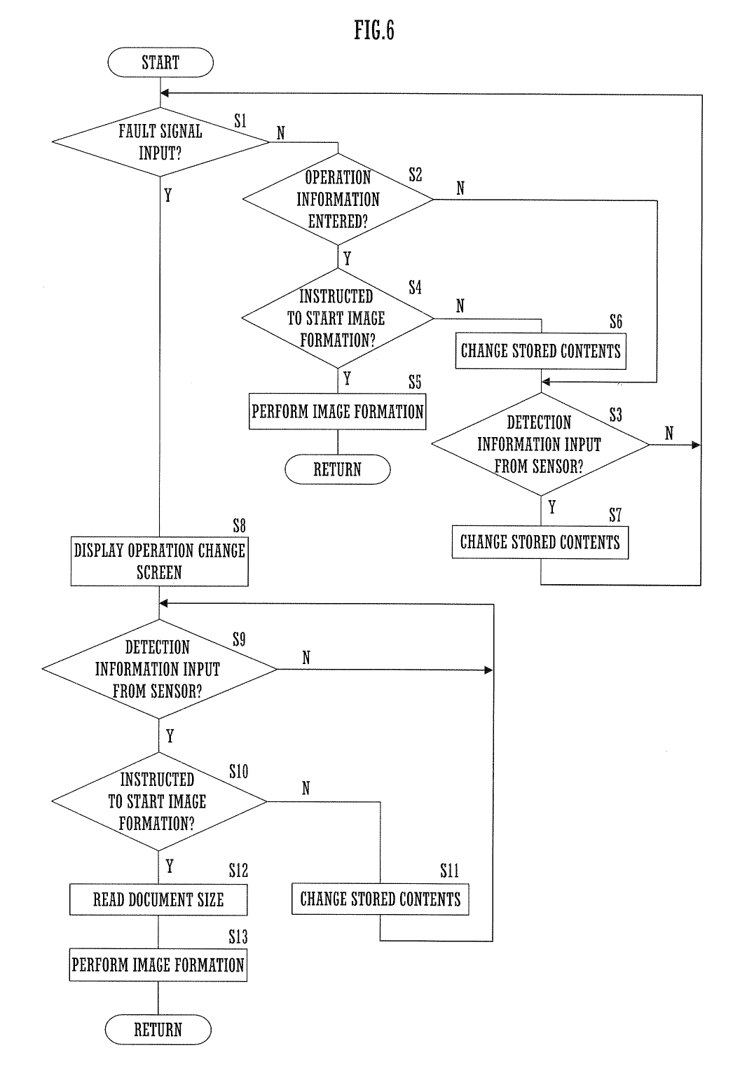

FIG. 6 is a flowchart showing the procedure performed by the control portion 5.

If the image forming apparatus 1 is switched on, the CPU 51 performs initial operation and subsequently determines whether the fault detector 58 has output a fault signal to the CPU (S1).

If no fault signal has been input to the CPU 51, the CPU waits for operation information from the input operation portion 6 and detection information from the document size sensors 81-84 (S2, S3).

If the CPU 51 is instructed to start the image forming processing, the CPU performs it based on the contents of the memory areas 531-534 of the RAM 53 (S4, S5).

If a piece of operation information corresponding to a piece of information of the first type has been input from the input operation portion 6 via the controller 57 to the CPU 51, the CPU changes the content of the associated memory area 531, 532 or 533 of the RAM 53 with reference to the memory area 521 of the ROM 52 (S6).

If one or more detection signals have been input from one or more of the document size sensors 81-84 to the CPU 51 while no fault signal is input to the CPU, the CPU changes the contents of the memory area 534 of the RAM 53 with reference to the memory area 523 of the ROM 52 (S7).

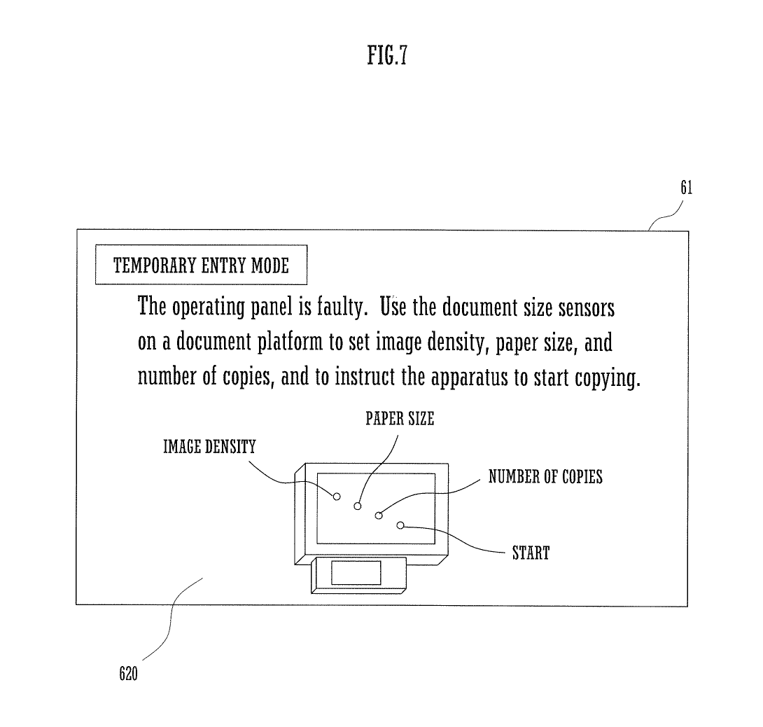

In the first embodiment, if a fault signal has been input the CPU 51, the CPU displays on the display 61 an operation change screen 620 as shown in FIG. 7 (S8). Then, the CPU 51 receives from one or more of the document size sensors 81-84 one or more detection signals representing a piece of information of the first type.

In accordance with the detection signal or signals from one or more of the document size sensors 81-83, the CPU 51 changes the contents of the associated memory area 531, 532 or 533 of the RAM 53 with reference to the memory area 522 of the ROM 52 (S9, S10). It is preferable that the CPU 51 should display the changed contents on the display 61.

If a detection signal is input from the document size sensor 84 to the CPU 51 (S11), with the fault signal input to the CPU, the CPU reads from the memory area 523 of the ROM 52 the document size represented by the detection signal or signals output from one or more of the document size sensors 81-84 after the automatic document feeder 200 is closed. The CPU 51 stores the read document size in the memory area 534 of the RAM 53 (S12).

Subsequently, the CPU 51 performs the image forming processing based on the contents of the memory areas 531-534 of the RAM 53 (S13).

Thus, even if the touch panel 62 of the singly installed apparatus 1 is faulty, the procedure shown by FIG. 6 makes it possible to enter image forming condition settings and an image forming processing start instruction into the control portion 5 by using the document size sensors 81-84, which are fitted to the apparatus.

It is possible to use, in place of the document size sensors 81-84, which detect document size, the sensor that detects whether one of the paper cassettes 41-44 is set in the image forming apparatus 1, the sensor that detects whether a sheet of paper is held on the hand-feed tray 45, or another sensor fitted to the apparatus.

As shown in FIG. 1, the document tray 201 of the automatic document feeder 200 is fitted with a document sensor 204, which detects whether a document is set on this tray.

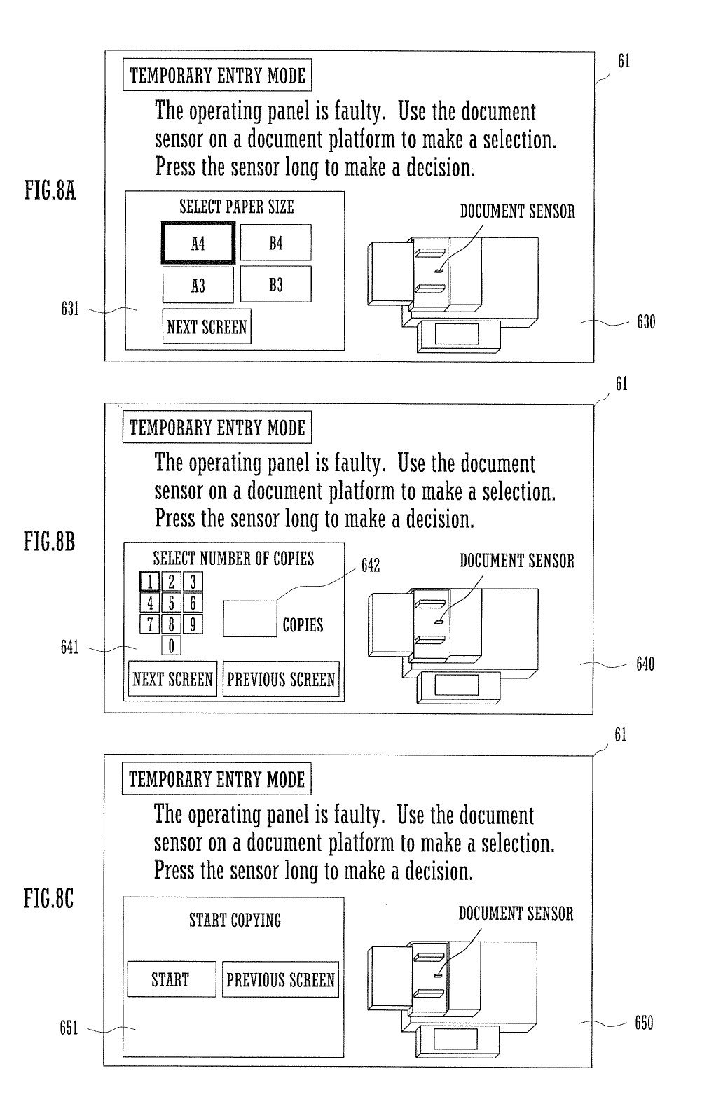

In a second embodiment of the present invention, the document sensor 204 is used to input information of the first type to the CPU 51. In this embodiment, the RAM 53 of the control portion 5 has a timer. The CPU 51 measures with the timer the time for which the document sensor 204 operates continuously. This embodiment will be described below with reference to FIGS. 8A-8C.

If the touch panel 62 is faulty, the CPU 51 displays on the display 61 an operation change screen 630 as shown by FIG. 8A and prompts a user to select paper size. The screen 630 includes a size display area 631, where four paper size icons and a next screen icon are displayed. The five icons are highlighted in order every time the document sensor 204 is pressed.

If user keeps pressing the document sensor 204 for a time longer than a specified value while one of the paper size icons on the operation change screen 630 is highlighted, the CPU 51 stores in the memory area 532 of the RAM 53 the highlighted size as the paper size decided by the user.

If the user keeps pressing the document sensor 204 for a time longer than the specified value while the next screen icon on the operation change screen 630 is highlighted, the CPU 51 displays on the display 61 an operation change screen 640 as shown by FIG. 8B and prompts the user to set the number of copies. The screen 640 includes an area 641 for showing the number of copies. In the area 641, ten key icons, a next screen icon, a previous screen icon, and a display box 642 are displayed. These twelve icons are highlighted in order every time the document sensor 204 is pressed.

If the user keeps pressing the document sensor 204 for a time longer than the specified value while one of the ten key icons on the operation change screen 640 is highlighted, the CPU 51 displays in the display box 642 the highlighted number as the number of copies decided by the user and stores this number in the memory area 533 of the RAM 53.

If the user keeps pressing the document sensor 204 for a time longer than the specified value while the previous screen icon on the operation change screen 640 is highlighted, the CPU 51 displays the operation change screen 630 on the display 61.

If the user keeps pressing the document sensor 204 for a time longer than the specified value while the next screen icon on the operation change screen 640 is highlighted, the CPU 51 displays on the display 61 an operation change screen 650 as shown by FIG. 8C and prompts the user to instruct the image forming apparatus 1 to start the image forming processing. The screen 650 includes a start display area 651, where a start icon and a previous screen icon are displayed. These two icons are highlighted in order every time the document sensor 204 is pressed.

If the user keeps pressing the document sensor 204 for a time longer than the specified value while the previous screen icon on the operation change screen 650 is highlighted, the CPU 51 displays the operation change screen 640 on the display 61.

If the user keeps pressing the document sensor 204 for a time longer than the specified value while the start icon on the operation change screen 650 is highlighted, the CPU 51 starts the image forming processing.

Thus, even if the touch panel 62 of the singly installed apparatus 1 is faulty, it is possible to receive image forming condition settings and an image forming processing start instruction by using the document sensor 204, which is fitted to the apparatus, and the timer for measuring the time for which this sensor is pressed.

In this embodiment, image density could be set on a screen similar to the operation change screens shown by FIGS. 8A and 8B.

The present invention being thus described, it will be obvious that the invention may be varied in many ways. Such variations are not to be regarded as a departure from the spirit and scope of the invention, and all such modifications as would be obvious to one skilled in the art are intended to be included within the scope of the following claims.

What is claimed is:

1. An image forming apparatus comprising:
an input operation portion for receiving input operation of information on image forming processing from a user;
an image forming portion for performing the image forming processing on a sheet of paper;
a fault detector for detecting a fault in the input operation portion;
a sensor for detecting the user's action for the image forming processing;
a first memory portion storing the correspondence of the user's input operation at the input operation portion to a first type of information on the image forming processing;
a second memory portion storing the correspondence of a detection result output from the sensor to the first type of information;
a third memory portion storing the correspondence of a detection result output from the sensor to a second type of information on the image forming processing; and
a control portion for controlling the image forming portion based on the contents of the first and third memory portions if the fault detector has detected no fault in the input operation portion, and for controlling the image forming portion based on the contents of the second and third memory portions if the detector has detected a fault in the input operation portion.

2. An image forming apparatus as claimed in claim 1, further comprising:
a paper holding portion for holding an unprinted sheet of paper; and
a paper delivery portion for holding a printed sheet of paper;
the image forming portion having a paper path along which the image forming apparatus conveys a sheet of paper from the paper holding portion to the paper delivery portion;
the sensor including a paper sensor for detecting the user's action of putting a sheet of paper in the paper holding portion.

3. An image forming apparatus as claimed in claim 1, further comprising an image reading portion for reading an image on a document;
the sensor including a document sensor for detecting the user's action of setting a document on the image reading portion.

4. An image forming apparatus as claimed in claim 2, further comprising an image reading portion for reading the image on a document;
the sensor including a document sensor for detecting the user's action of setting a document on the image reading portion.

5. An image forming apparatus as claimed in claim 1, further comprising a display portion for displaying display information including the first and second types of information;
wherein, after the fault detector detects a fault in the input operation portion, the control portion reads a piece of information of the first type from the second memory portion, the piece of information corresponding to the user's action detected by the sensor, and the control portion displays the read piece of information on the display portion.

6. An image forming apparatus as claimed in claim 2, further comprising a display portion for displaying display information including the first and second types of information;
wherein, after the fault detector detects a fault in the input operation portion, the control portion reads a piece of information of the first type from the second memory portion, the piece of information corresponding to the user's action detected by the sensor, and the control portion displays the read piece of information on the display portion.

7. An image forming apparatus as claimed in claim 3, further comprising a display portion for displaying display information including the first and second types of information;
wherein, after the fault detector detects a fault in the input operation portion, the control portion reads a piece of information of the first type from the second memory portion, the piece of information corresponding to the user's action detected by the sensor, and the control portion displays the read piece of information on the display portion.

8. An image forming apparatus as claimed in claim 4, further comprising a display portion for displaying display information including the first and second types of information;
wherein, after the fault detector detects a fault in the input operation portion, the control portion reads a piece of information of the first type from the second memory portion, the piece of information corresponding to the user's action detected by the sensor, and the control portion displays the read piece of information on the display portion.

9. An image forming apparatus as claimed in claim 1, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.

10. An image forming apparatus as claimed in claim 2, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.

11. An image forming apparatus as claimed in claim 3, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.

12. An image forming apparatus as claimed in claim 4, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.

13. An image forming apparatus as claimed in claim 5, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.

14. An image forming apparatus as claimed in claim 6, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.

15. An image forming apparatus as claimed in claim 7, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.

16. An image forming apparatus as claimed in claim 8, further comprising a timer for measuring the time for which a detection result output from the sensor keeps unchanged;
wherein, after the fault detector detects a fault in the input operation portion, the control portion stores a piece of information of the first type as a content set by the user, the piece of information corresponding to the user's action detected by the sensor lastly when the measured time has exceeded a specified value.
